(19) United States
(12) Patent Application Publication
(10) Pub. No.: US 2017/0127100 A1
(43) Pub. Date: May 4, 2017

(54) HYBRID BROADCAST SIGNAL TRANSMISSION AND RECEPTION APPARATUS AND TRANSMISSION AND RECEPTION METHOD

(71) Applicant: LG ELECTRONICS INC., Seoul (KR)

(72) Inventors: Woosuk KWON, Seoul (KR); Sejin OH, Seoul (KR); Kyoungsoo MOON, Seoul (KR)

(21) Appl. No.: 15/319,168

(22) PCT Filed: Jul. 7, 2015
(86) PCT No.: PCT/KR2015/006992

§ 371 Date: Dec. 15, 2016

Related U.S. Application Data
(60) Provisional application No. 62/021,684, filed on Jul. 7, 2014.

(51) Int. Cl. H04N 21/236; H04L 12/741; H04L 12/18; H04L 29/06; H04N 21/434; H04N 21/643

(52) U.S. Cl. CPC H04N 21/23605; H04N 21/4343; H04N 21/64322; H04L 12/18; H04L 69/22; H04L 45/74

(57) ABSTRACT

A hybrid broadcast signal transmission apparatus according to one embodiment of the present invention can comprise: a header repacking unit for receiving an upper (N+1) layer packet composed of a header including a plurality of fields and a payload including broadcast signal data, extracting at least one field included in the header of the received upper (N+1) layer packet, generating an N layer extended header including the extracted at least one field, and generating an (N+1) layer reduced header including fields not having been extracted from the header of the received upper (N+1) layer packet; and a packet generating unit for generating a fixed header of an N layer, generating the N layer packet including the generated fixed header, the N layer extended header, the (N+1) layer reduced header and the payload, and transmitting the generated N layer packet to a lower layer.

### TECHNICAL FIELD

The present invention relates to a hybrid broadcast signal transmission apparatus, a hybrid broadcast signal reception apparatus and a hybrid broadcast signal transmission and reception method.

### BACKGROUND ART

As analog broadcast signal transmission comes to an end, various technologies for transmitting/receiving digital broadcast signals are being developed. A digital broadcast signal may include a larger amount of video/audio data than an analog broadcast signal and further include various types of additional data in addition to the video/audio data.

### DISCLOSURE

### Technical Problem

Recently, in a broadcast and communication system, an environment using an IP has been gradually extended. In addition, in a next-generation broadcast system, a hybrid broadcast signal transmission and reception apparatus and method for providing a service using a broadcast network and an Internet protocol (IP) network will be used. Accordingly, a method of developing technologies related to a digital broadcast system using an existing IP is being considered. Even in a mobile communication system, an existing circuit network has gradually disappeared and switched to a packet network based on an IP. Accordingly, additional technology development is necessary for efficiency of data transmission and management at a protocol layer of a system using packets.

### Technical Solution

The object of the present invention can be achieved by providing a hybrid broadcast signal transmission method including receiving a higher (N+1) layer packet composed of a header including a plurality of fields and a payload including broadcast signal data, extracting at least one field included in the header of the received higher (N+1) layer packet, generating an N layer extended header including the extracted at least one field and generating an (N+1) layer reduced header including the fields which are not extracted from the header of the received higher (N+1) layer packet, generating a fixed header of an N layer, generating an N layer packet including the generated fixed header, the N layer extended header, the (N+1) layer reduced header and the payload, and transmitting the generated N layer packet to a lower layer.

### Advantageous Effects

Since a hybrid broadcast signal transmission apparatus according to an embodiment of the present invention combines and uses the same information between layers, it is possible to improve transmission efficiency.

Since a hybrid broadcast signal transmission apparatus according to an embodiment of the present invention uses header information of a higher layer without change, it is possible to reduce overhead for packet processing of a reception apparatus.

A hybrid broadcast signal transmission apparatus according to an embodiment of the present invention can include a function which is not supported by a protocol related thereto and may be associated with a newly established protocol.

In addition, a PDU packet generation method proposed by the present invention is applicable to an arbitrary layer on a protocol layer and is applicable to a broadcast and communication system based on an IP and all systems composed of protocol layers.

### DESCRIPTION OF DRAWINGS

The accompanying drawings, which are included to provide a further understanding of the present invention and are incorporated in and constitute a part of this application, illustrate embodiment(s) of the disclosure and together with the description serve to explain the principle of the present invention.

FIG. 1 is a diagram showing a protocol stack according to an embodiment of the present invention.

FIG. 2 is a diagram showing a data processing procedure of a protocol stack according to an embodiment of the present invention.

FIG. 3 is a diagram showing a procedure of configuring a PDU packet at a hybrid broadcast signal transmission apparatus according to an embodiment of the present invention.

FIG. 4 is a diagram showing a procedure of restoring a PDU packet at a hybrid broadcast signal reception apparatus according to an embodiment of the present invention.

FIG. 5 is a diagram showing a procedure of repacking a header of an IP packet at a hybrid broadcast signal transmission apparatus according to an embodiment of the present invention.

FIG. 6 is a diagram showing IP packet and header repacking according to an embodiment of the present invention.

FIG. 7 is a diagram showing a procedure of repacking a header of an IP packet at a hybrid broadcast signal transmission apparatus according to another embodiment of the present invention.

FIG. 8 is a diagram showing header repacking according to another embodiment of the present invention.

FIG. 9 is a diagram showing a hybrid broadcast signal reception apparatus according to an embodiment of the present invention.

FIG. 10 is a diagram showing an apparatus for processing at least one packet at layer N according to an embodiment of the present invention.

FIG. 11 is a flowchart illustrating a hybrid broadcast signal transmission method according to an embodiment of the present invention.

FIG. 12 is a flowchart illustrating a hybrid broadcast signal reception method according to an embodiment of the present invention.

### BEST MODE

Reference will now be made in detail to the preferred embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the present invention. The following detailed description includes specific details in order to provide a thorough understanding of the present invention. However, it will be apparent to those skilled in the art that the present invention may be practiced without such specific details.

Although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

The present invention provides apparatuses and methods for transmitting and receiving broadcast signals for next-generation broadcast services. Next-generation broadcast services according to an embodiment of the present invention include a terrestrial broadcast service, a mobile broadcast service, an ultra high definition television (UHDTV) service, etc.

Hereinafter, in content and data transmission through a system composed of protocol layers, a method of adding additional functions to the protocol layers to efficiently manage information or to enhance security will be described.

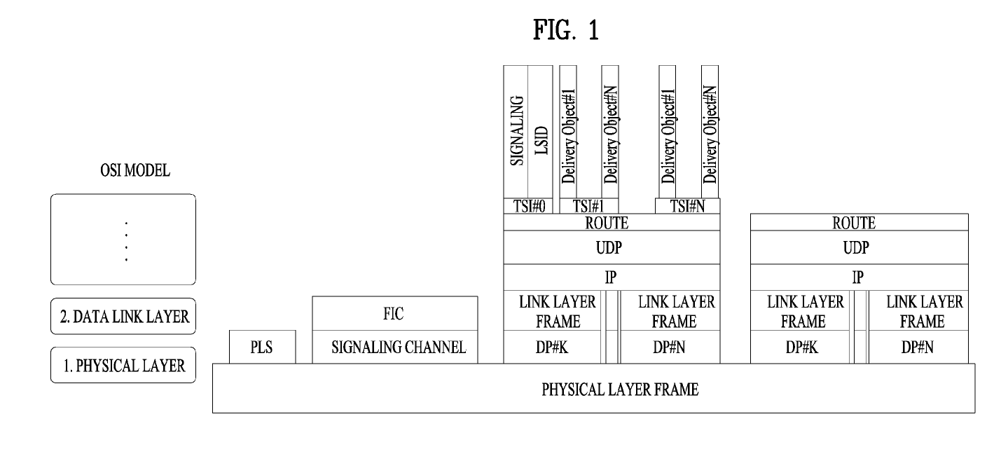

FIG. 1 is a diagram showing a protocol stack according to an embodiment of the present invention.

The protocol stack refers to a protocol system composed of a plurality of layers and may be implemented by hardware, software or a combination thereof. In general, a lower layer may be implemented by hardware and a higher layer may be implemented by software. Each layer may provide a function to a higher layer using only the function of a lower layer.

A broadcast signal transmission and reception system according to an embodiment of the present invention is composed of protocol layers and may be an open system interconnection (OSI) reference model developed by the International Organization for Standardization (ISO).

The OSI model may include a total of 7 layers including a physical layer, a data link layer, a network layer, a transport layer, a session layer, a presentation layer and an application layer. The physical layer is a lowest layer and the application layer is a highest layer. Hereinafter, the layers will be described.

The physical layer may be defined by the physical standards of data connection.

The data link layer may correct and acquire errors generated in the physical layer and provide a reliable link between directly connected two nodes. The data link layer according to an embodiment of the present invention may include a media access control (MAC) layer and a logical link control (LLC) layer.

The network layer is responsible for finding a route whenever passing through several nodes and may deliver data having various lengths over networks and provide functional and procedural means for providing quality of service (QoS) required by a transport layer in this procedure. The transport layer may enable end users to exchange reliable data with each other. Accordingly, higher layers may process data in consideration of validity or efficiency of data delivery.

The session layer may provide a method of managing communication at application processes of both ends.

The presentation layer may perform translation between network formats and an application and provide independency from data presentation.

The application layer may be directly associated with the application process to provide a general application service.

The blocks shown at the right side of FIG. 1 show a detailed protocol stack of the present invention corresponding to the above-described OSI model.

The physical layer according to an embodiment of the present invention may include a transmission medium such as a PLS or a signaling channel.

The data link layer according to an embodiment of the present invention may include an FIC, a link layer frame, etc. In addition, the higher layers of the data link layer may include IP, UDP, ROUTE, etc. as shown in FIG. 1.

The details of the layers included in the protocol stack shown in FIG. 1 may be changed according to designer's intention.

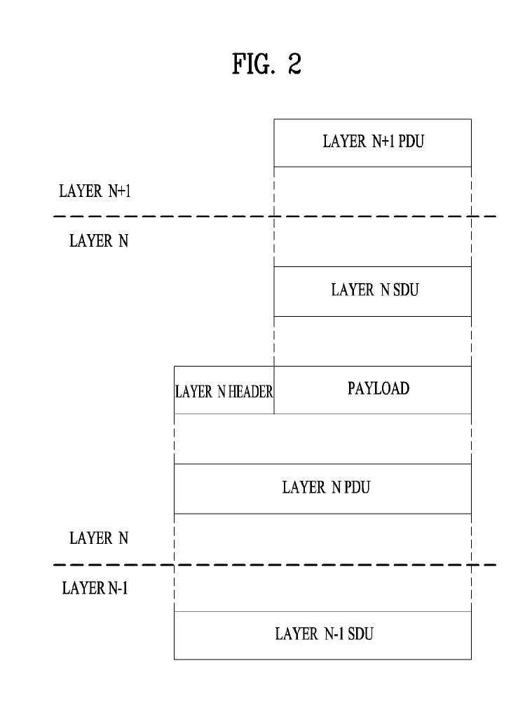

FIG. 2 is a diagram showing a data processing procedure of a protocol stack according to an embodiment of the present invention.

In an arbitrary protocol included in the above-described protocol stack, a packet received from a higher layer may be encapsulated and delivered to a lower layer.

In this case, the arbitrary layer may generate and deliver a protocol data unit (PDU) to a lower layer. The generated PDU may be defined as a service data unit (SDU) of a lower layer.

The PDU according to an embodiment of the present invention may be defined as a total amount of data or carriers generated in a corresponding layer and may be an encapsulated carrier obtained by combining a header including control information according to a function supported by the corresponding layer and data. The PDU may take the form of a packet or frame according to the properties of each layer.

The SDU may be defined as a data unit amount delivered to a lower layer and is data configuring a payload of the above-described PDU.

More specifically, as shown in the figure, the PDU generated at layer N+1 (or N+1 layer) may be delivered to next lower layer N (or lower N layer) and the delivered layer N+1 PDU may become an SDU of layer N.

In this case, the SDU of layer N may become the payload of the PDU of layer N and a header according to a function supported by layer N may be added to configure the PDU of layer N. When the generated PDU of layer N is delivered to a lower layer, that is, layer N−1 (or N−1 layer), the delivered layer N PDU may become an SDU of layer N−1.

That is, a specific layer may receive at least one PDU from a higher layer and generate at least one PDU based on the received PDU of the higher layer.

Recently, as a hybrid broadcast system using a broadcast network and an IP network has been established, demands for technologies for efficiently transmitting and managing data in the above-described protocol stack has increased.

Accordingly, the present invention proposes a method of generating a PDU packet of a lower layer using header information of a higher layer without adding a new field in order to reduce overhead for packet processing of a reception apparatus in encapsulation of a packet received from a higher layer and delivery of the encapsulated packet to a lower layer in a broadcast system composed of a plurality of protocol layers. In this case, since header fields having the same field between layers are combined and used, it is possible to improve transmission efficiency. The hybrid broadcast transmission apparatus according to an embodiment of the present invention may include a function which is not supported by a protocol related thereto and may be associated with a newly established protocol.

A PDU packet generation method proposed by the present invention is applicable to an arbitrary layer on a protocol layer and is applicable to a broadcast and communication system based on an IP and all systems composed of protocol layers.

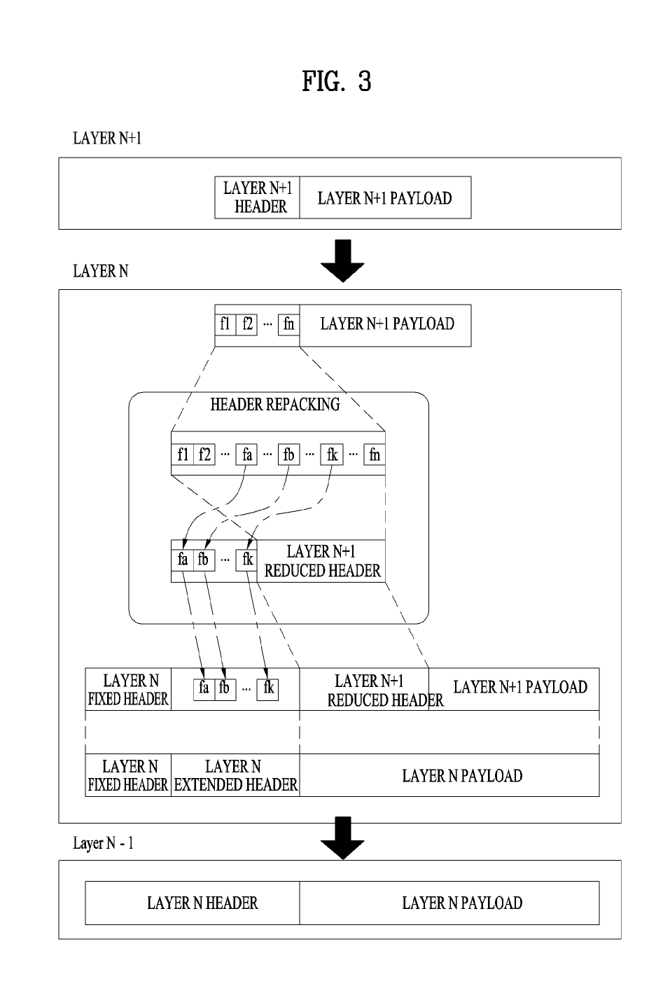

FIG. 3 is a diagram showing a procedure of configuring a PDU packet at a hybrid broadcast signal transmission apparatus according to an embodiment of the present invention.

More specifically, FIG. 3 shows a procedure of configuring a PDU packet of lower layer N using a field of a header of a PDU packet of higher layer N+1.

The block shown at the upper side of the figure shows a PDU packet (or packet) of higher layer N+1 including a header and a payload, and the block shown at the middle side of the figure shows a procedure of configuring the PDU packet of layer N. In addition, the block shown at the lower side of the figure shows the PDU packet of layer N transmitted to layer N−1. As shown in the figure, the PDU packet of layer N may include a header and a payload and may become an SDU of layer N−1.

The packet of higher layer N+1 according to an embodiment of the present invention may include at least one field and the fields may be denoted by f1, f2, . . . , and fn. The sizes of the fields may be determined according to the definition of the protocol.

If the attributes of some fields fa, fb, . . . , and fk (1≦a, b, . . . , k≦n) included in the packet of layer N+1 are applied to a lower layer, that is, layer N, without change, the hybrid broadcast signal transmission apparatus according to an embodiment of the present invention may distinguishably rearrange extracted fields and non-extracted fields included in the header of the packet of layer N+1.

In this case, the header of the packet of protocol layer N+1 excluding the extracted fields may be rearranged according to the order of fields of protocol layer N. In the present invention, this procedure may be referred to as header repacking and a header of the packet of layer N+1 composed of the fields left after extracting some fields may be referred to as a reduced header. In addition, as shown in the figure, the fields fa, fb, . . . , and fk extracted from the header of the packet of layer N+1 may be respectively included or combined and included in the header of layer N. In this case, arrangement of the fields may be changed according to the order of protocol fields defined in layer N. In the present invention, a header part including the fields extracted from the header of the packet of higher layer N+1 may be referred to as an extended header, in order to distinguish between layer N+1 and layer N.

As a result, after header repacking, the header of the packet of layer N may include a fixed header of layer N and an extended header of layer N, and the payload of the packet of layer N may include a layer N+1 reduced header and a layer N+1 payload.

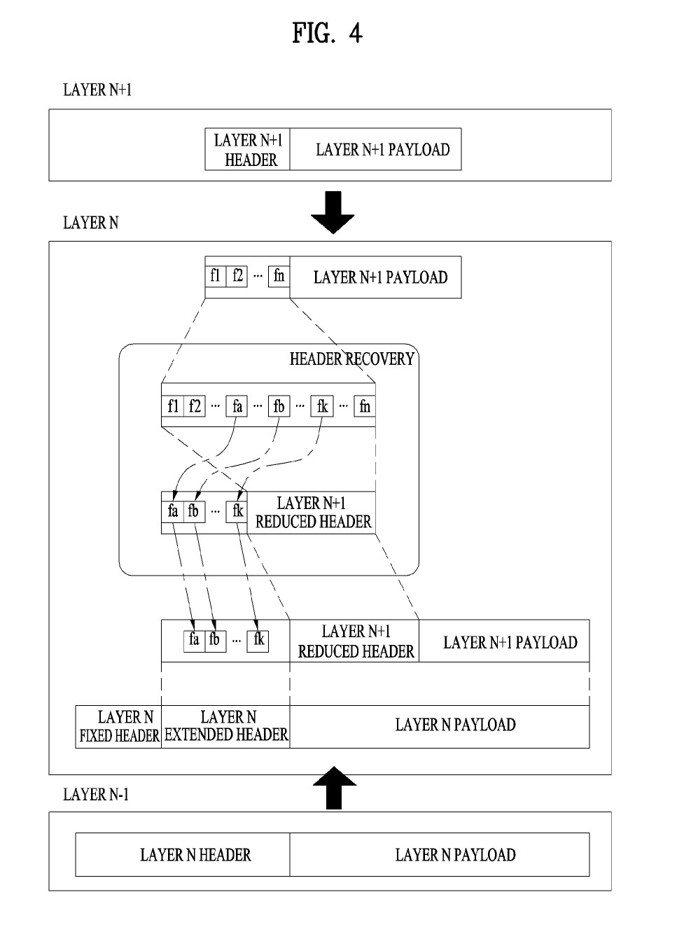

FIG. 4 is a diagram showing a procedure of restoring a PDU packet at a hybrid broadcast signal reception apparatus according to an embodiment of the present invention.

FIG. 4 shows an inverse procedure of the hybrid broadcast signal transmission apparatus described with reference to FIG. 3. More specifically, the hybrid broadcast signal reception apparatus according to an embodiment of the present invention may restore a higher layer packet header included in a lower layer packet header.

The block shown at the upper side of the figure shows a PDU packet (or packet) of higher layer N+1 including a header and a payload, and the block shown at the middle side of the figure shows a procedure of configuring the PDU packet of layer N. In addition, the block shown at the lower side of the figure shows the packet transmitted from layer N−1 to layer N. As shown in the figure, the PDU packet of layer N may include a header and a payload and may become an SDU of layer N−1.

The hybrid broadcast signal reception apparatus according to an embodiment of the present invention may restore the header of higher layer N+1 in a direction denoted by an arrow shown in the figure.

The packet delivered from layer N−1 may include a header and a payload which may be parsed in layer N. As described with reference to FIG. 3, when the broadcast signal transmission apparatus performs header repacking, the hybrid broadcast signal reception apparatus according to an embodiment of the present invention may confirm the fields fa, fb, . . . , and fk of layer N+1 included in the layer N extended header. As described above, since arrangement of the fields fa, fb, . . . , and fk of layer N+1 extracted through header repacking may be changed according to the order of protocol fields defined in layer N, the hybrid broadcast signal reception apparatus according to an embodiment of the present invention may find the fields according to the order of protocol fields of layer N.

As one embodiment of the present invention, if the fields fa, fb, . . . , and fk of layer N+1 are aligned in the order of fields located in the header of the packet of layer N+1, a combination of the fields may be located from a start part of the extended header of layer N. Accordingly, the hybrid broadcast signal reception apparatus may perform search from the start part of the extended header to find the fields of layer N+1 and acquire the fields included in the reduced header of layer N+1 included in the payload of layer N to restore the layer N+1 packet header.

In the present embodiment, this procedure may be referred to as header recovery and the extracted layer N+1 packet may be delivered to higher layer N+1 after header recovery.

Hereinafter, an embodiment of repacking the header of an IP packet if a broadcast signal is an IP will be described.

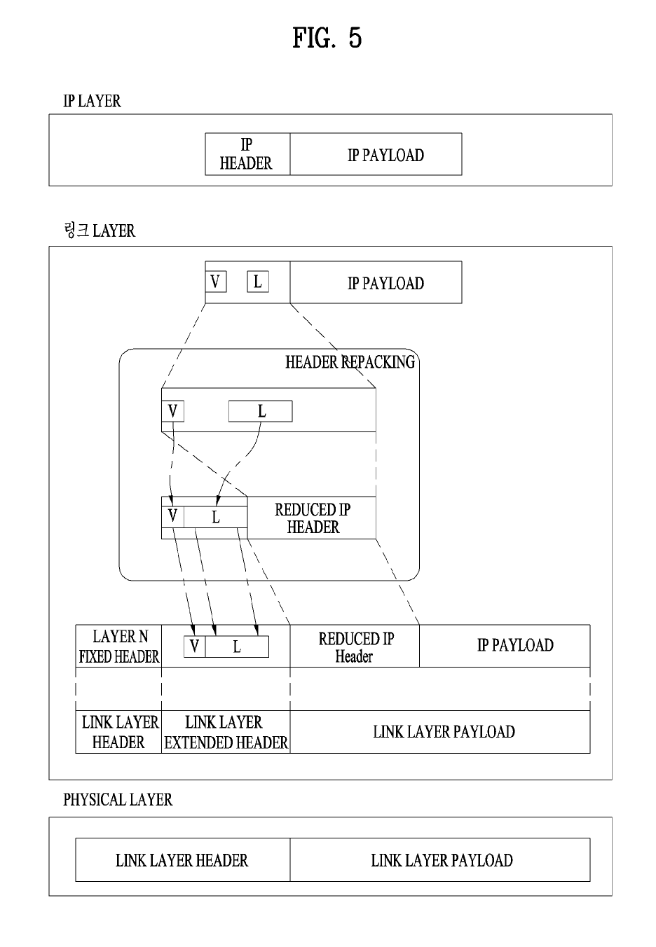

FIG. 5 is a diagram showing a procedure of repacking a header of an IP packet at a hybrid broadcast signal transmission apparatus according to an embodiment of the present invention.

More specifically, FIG. 5 shows a procedure of performing header repacking at a link layer located between a physical layer and an IP layer among the protocol layers according to an embodiment of the present invention. The link layer according to an embodiment of the present invention may be referred to as a data link layer or layer 2 according to designer's intention.

The block shown at the upper side of the figure shows a packet of a higher IP layer including an IP header and an IP payload, and the block shown at the middle side of the figure shows a procedure of configuring the packet of a link layer. In addition, the block shown at the lower side of the figure shows the packet of the link layer transmitted to the physical layer. As shown in the figure, the packet of the link layer may include a header and a payload.

Header repacking of the link layer is equal to header repacking described with reference to FIG. 3. In particular, the hybrid broadcast signal transmission apparatus according an embodiment of the present invention may perform header repacking to extract a version field and a packet length field from an IP packet header if the version field (v) and the packet length field (L) included in the IP packet header are used in the header of the link layer packet without change. Accordingly, the link layer packet subjected to header repacking may include a link layer header, a link layer extended header and a link layer payload, and the link layer payload may include a reduced IP header.

The hybrid broadcast signal reception apparatus according to an embodiment of the present invention may perform header recovery described with reference to FIG. 4 to restore the IP packet subjected to header repacking of FIG. 5. Details thereof are equal to the description of FIG. 4 and will be omitted.

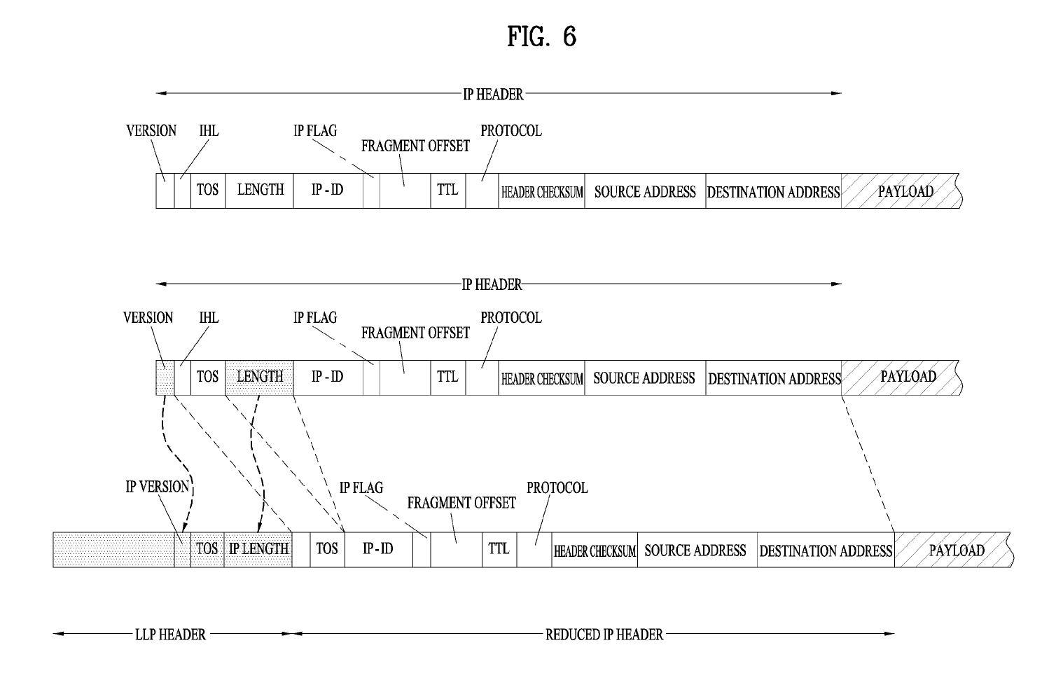

FIG. 6 is a diagram showing IP packet and header repacking according to an embodiment of the present invention.

The block shown at the upper side of the figure shows an IP packet and the block shown at the lower side of the figure shows header repacking of the above-described link layer.

As shown at the upper side of the figure, the IP packet according to an embodiment of the present invention may include a packet header and a payload. The uncolored blocks in the block shown at the upper side of the figure indicates the header of the IP packet and the colored block indicates the payload of the IP packet. The IP packet header of the present invention may include a version field, an IP header length (IHL) field, a type of service (ToS) field, a length field, an IP-ID field, an IP flag field, a fragment offset field, a time to live (TTL) field, a protocol field, a header checksum field, a source address field and a destination field.

The version field means an Internet protocol version.

The IHL field indicates the length of the IP protocol header.

The ToS field may indicate quality of service (QoS) of a datagram.

The length field indicates the total length of the IP packet.

The IP flag field indicates a field for fragmentation of an IP datagram.

The fragment offset field indicates the location of a fragment.

The TTL field indicates the number of passable remaining routers.

The protocol field indicates information on a higher protocol included in data.

The header checksum field may be used to check errors of the header in order to prevent the header from being damaged during transmission.

The source address field indicates the address of a source.

The destination address field indicates the address of a destination.

The names and locations of the fields may be changed according to designer's intention.

As shown at the lower side of the figure, the hybrid broadcast signal transmission apparatus according to an embodiment of the present invention may receive an IP packet from a link layer and then perform header repacking to extract a version field (v) and a length field (L) included in an IP packet header. The extracted version field (v) and length field (L) may be included in the header of a link layer packet (LLP) and the remaining fields of the IP packet header may be sequentially arranged to configure a reduced IP packet header.

The version field (v) and the length field (L) may be arranged in the header of the LLP according to the order of protocol fields defined in the link layer. This figure shows an embodiment in which the version field (v) and the length field (L) are added to the extended header of the LLP in order to distinguish between the LLP and the IP packet. As described above, the reduced IP packet header and IP packet payload of the IP packet may configure the payload of the LLP.

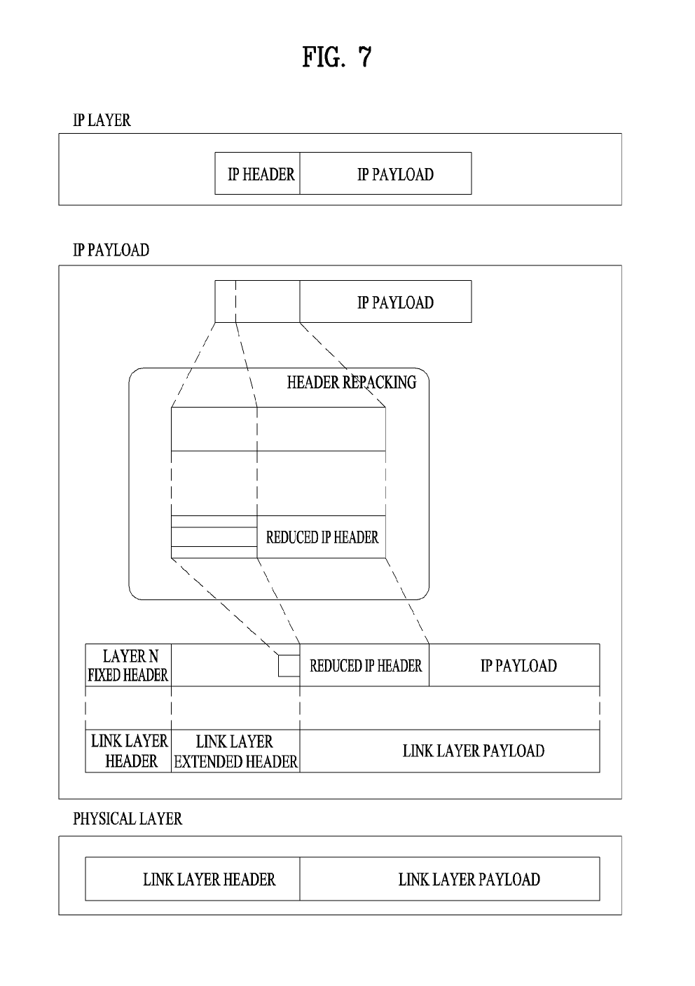

FIG. 7 is a diagram showing a procedure of repacking a header of an IP packet at a hybrid broadcast signal transmission apparatus according to another embodiment of the present invention.

FIG. 7 shows a header repacking procedure of including a corresponding part of an IP packet header in an LLP header without change if a field to be included in the header of the LLP among the fields included in the IP packet header is located at a front part of the IP packet. In this case, fields which are not used in the link layer may be included in the LLP header, in order to conveniently configure the packet. A part of the IP packet header is included in the LLP header as a link layer extended header.

The hybrid broadcast signal reception apparatus according to an embodiment of the present invention performs header recovery described with reference to FIG. 4 to restore the IP packet subjected to header repacking of FIG. 7. Details thereof are equal to the description of FIG. 4 and thus will be omitted.

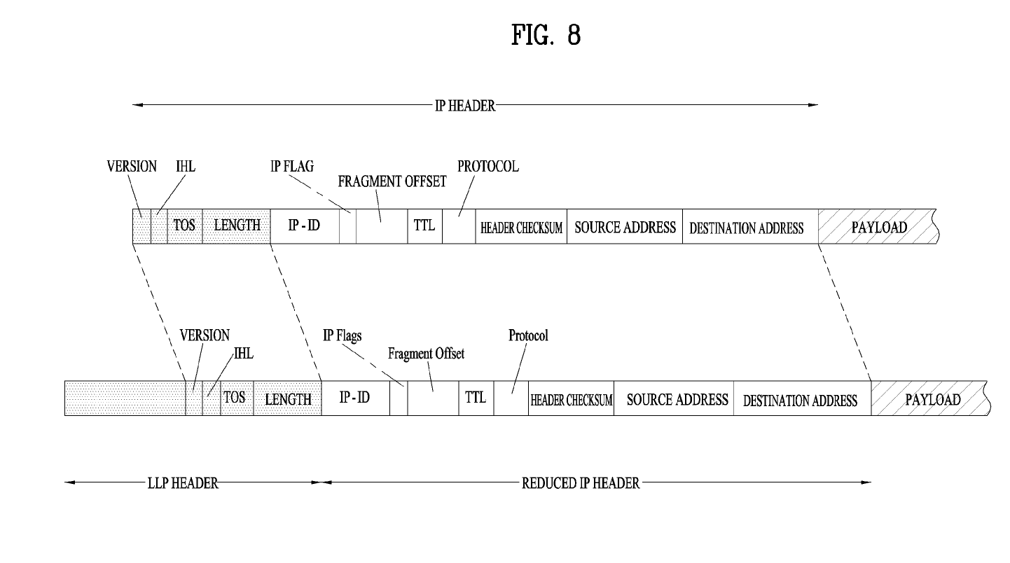

FIG. 8 is a diagram showing header repacking according to another embodiment of the present invention.

More specifically, FIG. 8 shows header repacking described with reference to FIG. 7. As described above, the hybrid broadcast signal transmission apparatus according to an embodiment of the present invention may receive an IP packet from a link layer and then perform header repacking to extract a part of an IP packet header. The extracted part of the IP packet header may be included in the header of a link layer packet and the remaining fields of the IP packet header may be sequentially arranged to configure a reduced IP packet header.

In this figure, a procedure of extracting a 4-byte front part of an IPv4 packet is shown. In this case, the version field (v), the IHL field, the ToS field and the length field (L) may be arranged in the header of the LLP according to the order of protocol fields defined in the link layer. This figure shows an embodiment in which the version field (v), the IHL field, the ToS field and the length field (L) are added to the extended header of the LLP in order to distinguish between the LLP and the IP packet. As described above, the reduced IP packet header and IP packet payload of the IP packet may configure the payload of the LLP.

In the case of header repacking, since transformation of a higher layer packet is not necessary and the packet may be processed according to the order of bit streams, it is possible to reduce complexity of the processing procedure. In addition, it is possible to reduce overhead for transmission of the fields having the same roles between the layers. In addition, it is possible to reduce complexity of the processing procedure in the transmission and reception apparatus as compared to the case of adding a separate field.

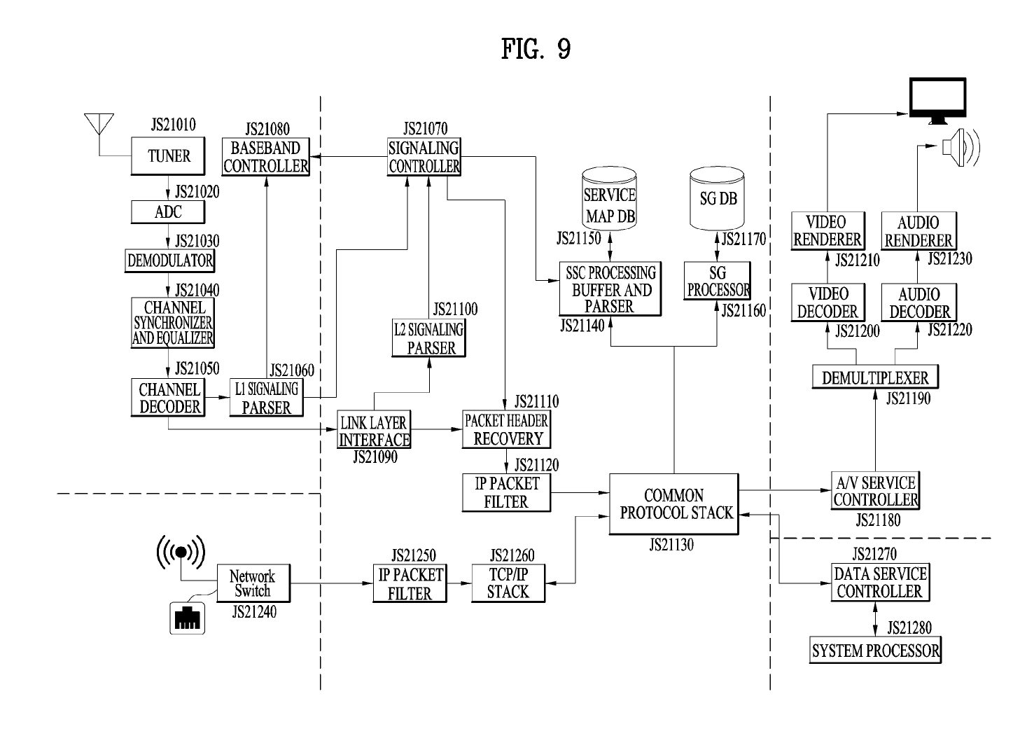

FIG. 9 is a diagram showing a hybrid broadcast signal reception apparatus according to an embodiment of the present invention.

FIG. 9 shows the structure of a hybrid broadcast signal reception apparatus for processing a broadcast signal when header repacking described with reference to FIGS. 2 to 8 is performed at a link layer.

The reception apparatus according to an embodiment of the present invention includes a tuner JS21010, an ADC JS21020, a demodulator JS21030, a channel synchronizer and equalizer JS21040, a channel decoder JS21050, an L1 signaling parser JS21060, a signaling controller JS21070, a baseband controller JS21080, a link layer interface JS21090, an L2 signaling parser JS21100, a packet header recovery unit JS21110, an IP packet filter JS21120, a common protocol stack processor JS21130, an SSC processing buffer and parser JS21140, a service map database JS21150, a service guide processor JS21160, a service guide database JS21170, an AV service controller JS21180, a demultiplexer JS21190, a video decoder JS21200, a video renderer JS21210, an audio decoder JS21220, an audio renderer JS21230, a network switch JS21240, an IP packet filter JS21250, a TCP/IP stack processor JS21260, a data service controller JS21270 and/or a system processor JS21280. Hereinafter, the blocks will be described.

The tuner JS21010 receives a broadcast signal.

When the broadcast signal is an analog signal, the ADC JS21020 converts the analog signal into a digital signal.

The demodulator JS21030 demodulates the broadcast signal.

The channel synchronizer and equalizer JS21040 performs channel synchronization and/or equalization.

The channel decoder JS21050 decodes the channel in the broadcast signal.

The L1 signaling parser JS21060 parses L1 signaling information from the decoded broadcast signal. The L1 signaling information means signaling information of a physical layer and may be transmitted through a specific region of the frame of the physical layer. The L1 signaling information according to an embodiment of the present invention may include transmission parameters such as code information and modulation information of broadcast data processed at the physical layer.

The signaling controller JS21070 processes the signaling information or delivers the signaling information to a device which requires the signaling information in the broadcast reception apparatus.

The baseband controller JS21080 controls processing of the broadcast signal in a baseband. The baseband controller JS21080 may perform data processing at the physical layer for the broadcast signal using the L1 signaling information. Even when a connection relationship between the baseband controller JS21080 and other devices are not shown, the baseband controller may deliver the processed broadcast signal or broadcast data to the other devices of the reception apparatus.

The link layer interface JS21090 accesses and acquires a link layer packet. As described above, the link layer packet may be subjected to header repacking described with reference to FIGS. 2 to 8 and then transmitted.

The L2 signaling parser JS21100 parses L2 signaling information. The L2 signaling information may correspond to information included in the above-described link layer signaling packet.

The packet header recovery unit JS21110 performs header recovery described with reference to FIG. 4 when the packet of the layer higher than the link layer (e.g., IP packet) is subjected to header repacking. Details thereof are equal to the description of FIGS. 2 to 8 and thus will be omitted.

The IP packet filter JS21120 filters an IP packet transmitted to a specific IP address and/or UDP number. The IP packet transmitted to the specific IP address and/or UDP number may include signaling information transmitted through a dedicated channel. The dedicated channel may be defined as a data channel allocated for a special purpose. Accordingly, the IP packet transmitted to the specific IP address and/or UDP number may include an FIC, an FIT, an EAT and/or an emergency alert message (EAM).

The common protocol stack processor JS21130 processes data according to the protocol of each layer. For example, the common protocol stack processor JS21130 decodes or parses the IP packet according to the protocol of an IP layer and/or a layer higher than the IP layer.

The SSC processing buffer and parser JS21140 stores or parses signaling information delivered through a service signaling channel (SSC). A specific IP packet may be designated as an SSC and the SSC may include information for acquiring a service, attribute information of content included in the service, DVB-SI information and/or PSI/PSIP information.

The service map database JS21150 stores a service map table. The service map table includes attribute information of a broadcast service. The service map table may be included and transmitted in the SSC.

The service guide processor JS21160 parses or decodes service guide.

The service guide database JS21170 stores service guide.

The AV service controller JS21180 performs overall control for acquiring broadcast AV data.

The demultiplexer JS21190 demultiplexes broadcast data into video data and audio data.

The video decoder JS21200 decodes the video data.

The video renderer JS21210 generates video presented to a user using the decoded video data.

The audio decoder JS21220 decodes the audio data.

The audio renderer JS21230 generates audio presented to the user using the decoded audio data.

The network switch JS21240 controls an interface with another network in addition to a broadcast network. For example, the network switch JS21240 may access the IP network and directly receive an IP packet.

The IP packet filter JS21250 filters an IP packet having a specific IP address and/or UDP number.

The TCP/IP stack processor JS21260 may decapsulate the IP packet according to the protocol of TCP/IP.

The data service controller JS21270 controls processing of a data service.

The system processor JS21280 performs overall control of the reception apparatus.

The names/locations/functions of the blocks shown in this figure may be changed according to designer's intention.

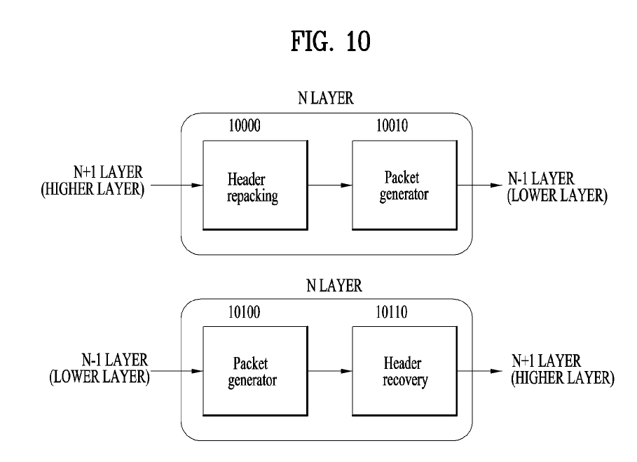

FIG. 10 is a diagram showing an apparatus for processing at least one packet at layer N according to an embodiment of the present invention.

The block shown at the upper side of the figure shows a device for processing a packet in a transmission apparatus corresponding to an arbitrary N layer and the block shown at the lower side of the figure shows a device for processing a packet in a reception apparatus.

The packet processing device in the transmission apparatus according to an embodiment of the present invention may include a header repacking unit 10000 and a packet generator 10010 and the packet processing device in the reception apparatus according to an embodiment of the present invention may include a packet generator 10100 and a header recovery unit 10110. Hereinafter, operation of the blocks will be described.

The header repacking unit 10000 according to an embodiment of the present invention may receive a PDU (or packet) from higher layer N+1 and perform header repacking. Details thereof were described with reference to FIGS. 2 to 8. Hereinafter, the packet generator 10010 according to an embodiment of the present invention may generate the packet of layer N using the packet header of the higher layer subjected to repacking and then and transmit the packet of layer N to lower layer N−1. Details thereof were described with reference to FIGS. 2 to 8.

The packet generator 10100 according to an embodiment of the present invention may receive an SDU from lower layer N−1 and acquire a header and a payload configuring the N layer packet. Details thereof were described with reference to FIGS. 2 to 9. Thereafter, the header recovery unit 10110 according to an embodiment of the present invention may perform header recovery with respect to the acquired header. Details thereof were described with reference to FIGS. 2 to 9. The packet generator 10100 and the header recovery unit 10110 may be included in the packet header recovery unit JS21110 described with reference to FIG. 9, which may be changed according to designer's intention.

Lower layer N−1 according to an embodiment of the present invention may be a physical layer, layer N may be a link layer and higher layer N+1 may be an IP layer, which may be changed according to designer's intention.

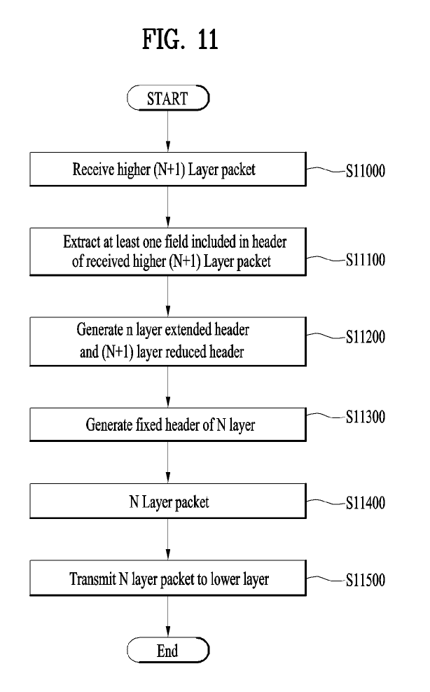

FIG. 11 is a flowchart illustrating a hybrid broadcast signal transmission method according to an embodiment of the present invention.

The header repacking unit 10000 included in the hybrid broadcast signal transmission apparatus according to an embodiment of the present invention may receive at least one higher N+1 layer PDU (S11000). Details thereof were described with reference to FIGS. 2 to 10.

Thereafter, the header repacking unit 10000 included in the hybrid broadcast signal transmission apparatus according to an embodiment of the present invention may extract at least one field included in the header of the higher (N+1) layer packet (S11100).

Details thereof were described with reference to FIGS. 2 to 10.

Thereafter, the header repacking unit 10000 included in the hybrid broadcast signal transmission apparatus according to an embodiment of the present invention may generate an N layer extended header including the extracted at least one field and generate an (N+1) layer reduced header including the fields which are not extracted from the header of the received higher (N+1) layer packet. Details thereof were described with reference to FIGS. 2 to 10.

Thereafter, the packet generator 10010 included in the hybrid broadcast signal transmission apparatus according to an embodiment of the present invention may generate a fixed header of an N layer (S11300), generate the N layer packet including the generated fixed header, an N layer extended header, an (N+1) layer reduced header and a payload (S11400), and transmit the generated N layer packet to a lower layer (S11500). Details thereof were described with reference to FIGS. 2 to 10. A lower (N−1) layer according to an embodiment of the present invention may be a physical layer, the N layer may be a link layer and the higher (N+1) layer may be an IP layer, which may be changed according to designer's intention.

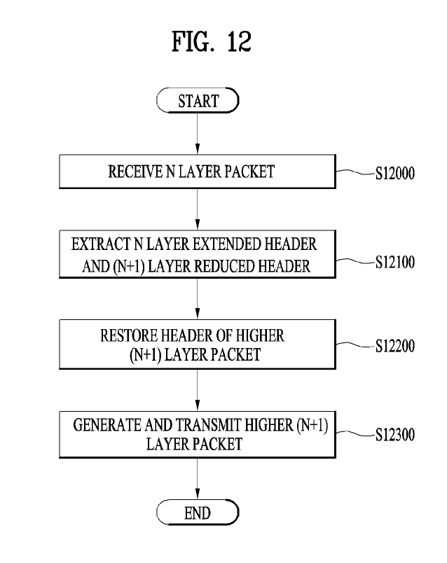

FIG. 12 is a flowchart illustrating a hybrid broadcast signal reception method according to an embodiment of the present invention.

FIG. 12 shows an inverse process of the hybrid broadcast signal transmission method described with reference to FIG. 11.

The packet generator 10100 included in the hybrid broadcast signal reception apparatus according to an embodiment of the present invention may receive an N layer packet including a header and a payload (S12000). As described above, the packet generator 10100 may acquire the header and the payload from the received N layer packet. Details thereof were described with reference to FIGS. 2 to 10.

Thereafter, the header recovery unit 10110 included in the hybrid broadcast signal reception apparatus according to an embodiment of the present invention may extract an N layer extended header and an (N+1) layer reduced header (S12100). The header recovery unit 10110 included in the hybrid broadcast signal reception apparatus according to an embodiment of the present invention may acquire fields included in the extracted N layer extended header and fields included in the extracted (N+1) layer reduced header and restore the header of the higher (N+1) layer packet (S12200). Thereafter, the header recovery unit 10110 included in the hybrid broadcast signal reception apparatus according to an embodiment of the present invention generates and transmits the higher (N+1) layer packet (S12300). Details thereof were described with reference to FIGS. 2 to 10.

Modules or units may be processors executing consecutive processes stored in a memory (or a storage unit). The steps described in the aforementioned embodiments can be performed by hardware/processors. Modules/blocks/units described in the above embodiments can operate as hardware/processors. The methods proposed by the present invention can be executed as code. Such code can be written on a processor-readable storage medium and thus can be read by a processor provided by an apparatus.

### MODE FOR INVENTION

Various embodiments have been described in the best mode for carrying out the invention.

### INDUSTRIAL APPLICABILITY

The present invention is applicable to broadcast signal providing fields.

Various equivalent modifications are possible within the spirit and scope of the present invention, as those skilled in the relevant art will recognize and appreciate. Accordingly, it is intended that the present invention cover the modifications and variations of this invention provided they come within the scope of the appended claims and their equivalents.

1. A hybrid broadcast signal transmission method comprising:
receiving a higher (N+1) layer packet composed of a header including a plurality of fields and a payload including broadcast signal data;
extracting at least one field included in the header of the received higher (N+1) layer packet;
generating an N layer extended header including the extracted at least one field and generating an (N+1) layer reduced header including the fields which are not extracted from the header of the received higher (N+1) layer packet;
generating a fixed header of an N layer;
generating an N layer packet including the generated fixed header, the N layer extended header, the (N+1) layer reduced header and the payload; and
transmitting the generated N layer packet to a lower layer.

2. The hybrid broadcast signal transmission method according to claim 1, wherein the N layer extended header is arranged after the fixed header.

3. The hybrid broadcast signal transmission method according to claim 2, wherein the (N+1) layer reduced header is included in the payload of the N layer packet.

4. The hybrid broadcast signal transmission method according to claim 1, wherein, if the higher (N+1) layer packet is an Internet protocol (IP) packet, the extracted at least one field includes a version field and a length field.

5. The hybrid broadcast signal transmission method according to claim 1, wherein, if the higher (N+1) layer packet is an Internet protocol (IP) packet, the extracted at least one field includes a 4-bit front part of an IP packet header.

6. A hybrid broadcast signal transmission apparatus comprising:
a header repacking unit for receiving a higher (N+1) layer packet composed of a header including a plurality of fields and a payload including broadcast signal data, extracting at least one field included in the header of the received higher (N+1) layer packet, generating an N layer extended header including the extracted at least one field, and generating an (N+1) layer reduced header including the fields which are not extracted from the header of the received higher (N+1) layer packet; and
a packet generator for generating a fixed header of an N layer, generating an N layer packet including the generated fixed header, the N layer extended header, the (N+1) layer reduced header and the payload, and transmitting the generated N layer packet to a lower layer.

7. The hybrid broadcast signal transmission apparatus according to claim 6, wherein the N layer extended header is arranged after the fixed header.

8. The hybrid broadcast signal transmission apparatus according to claim 7, wherein the (N+1) layer reduced header is included in the payload of the N layer packet.

9. The hybrid broadcast signal transmission apparatus according to claim 6, wherein, if the higher (N+1) layer packet is an Internet protocol (IP) packet, the extracted at least one field includes a version field and a length field.

10. The hybrid broadcast signal transmission apparatus according to claim 6, wherein, if the higher (N+1) layer packet is an Internet protocol (IP) packet, the extracted at least one field includes a 4-bit front part of an IP packet header.

11. A hybrid broadcast signal reception method comprising:
receiving an N layer packet including a header and a payload;
extracting an N layer extended header from the header of the received N layer packet and extracting an (N+1) layer reduced header from the payload;
acquiring fields included in the extracted N layer extended header and fields included in the extracted (N+1) layer reduced header to restore a header of a higher (N+1) layer packet; and
generating and transmitting the higher (N+1) layer packet.

12. The hybrid broadcast signal reception method according to claim 11, wherein the N layer extended header is arranged after the fixed header.

13. The hybrid broadcast signal reception method according to claim 11, wherein, if the higher (N+1) layer packet is an Internet protocol (IP) packet, the extracted at least one field includes a version field and a length field.

14. The hybrid broadcast signal reception method according to claim 11, wherein, if the higher (N+1) layer packet is an Internet protocol (IP) packet, the extracted at least one field includes a 4-bit front part of an IP packet header.

15. A hybrid broadcast signal reception apparatus comprising:
a packet generator for receiving an N layer packet and acquiring a header and a payload from the received N layer packet; and
a header recovery unit for extracting an N layer extended header from the acquired header of the N layer packet and extracting an (N+1) layer reduced header from the acquired payload, acquiring fields included in the extracted N layer extended header and fields included in the extracted (N+1) layer reduced header to restore a header of a higher (N+1) layer packet, and generating and transmitting the higher (N+1) layer packet.

16. The hybrid broadcast signal reception apparatus according to claim 15, wherein the N layer extended header is arranged after the fixed header.

17. The hybrid broadcast signal reception apparatus according to claim 15, wherein, if the higher (N+1) layer packet is an Internet protocol (IP) packet, the extracted at least one field includes a version field and a length field.

18. The hybrid broadcast signal reception apparatus according to claim 15, wherein, if the higher (N+1) layer packet is an Internet protocol (IP) packet, the extracted at least one field includes a 4-bit front part of an IP packet header.
